(19) United States
(12) Patent Application Publication
(10) Pub. No.: US 2019/0295043 A1
(43) Pub. Date: Sep. 26, 2019

(54) SYSTEM AND METHOD FOR MACHINE LEARNING BASED INVENTORY MANAGEMENT

(71) Applicants: Kabushiki Kaisha Toshiba, Minato-ku (JP); Toshiba TEC Kabushiki Kaisha, Shinagawa-ku (JP)

(72) Inventors: Michael YEUNG, Mission Viejo, CA (US); Manju SREEKUMAR, Irvine, CA (US); Milong SABANDITH, Irvine, CA (US); Methee PHOBOONME, Irvine, CA (US); Louis ORMOND, Irvine, CA (US)

(21) Appl. No.: 15/934,135

(22) Filed: Mar. 23, 2018

(51) Int. Cl. G06Q 10/00; G06Q 30/06; G06N 99/00

(52) U.S. Cl. CPC G06Q 10/20; G06N 99/005; G06Q 30/0633

(57) ABSTRACT

A system and method for predictive inventory management includes a processor and memory. A network interface receives device status data from each of a plurality of multifunction peripherals into the memory. The memory stores service history data and service call history data for the multifunction peripherals, in addition to replacement parts data corresponding to replacement parts used in prior device repairs. The processor detects patterns in the service history data, the service call history data and the replacement parts data and generates predictive replacement part data for future replacement parts that will be needed based on the device status data and the detected patterns. The processor then outputs the predictive replacement part data.

### TECHNICAL FIELD

This application relates generally to inventory management for supporting document processing devices. The application relates more particularly to advance ordering of document processing parts in accordance with predictive need based on prior service calls and replacement parts used.

### SUMMARY

In an example embodiment a system and method for predictive inventory management includes a processor sand memory. A network interface receives device status data from each of a plurality of multifunction peripherals into the memory. The memory stores service history data and service call history data for the multifunction peripherals, in addition to replacement parts data corresponding to replacement parts used in prior device repairs. The processor detects patterns in the service history data, the service call history data and the replacement parts data and generates predictive replacement part data for future replacement parts that will be needed based at least in part on the detected patterns and the received device status data. The process then outputs the predictive replacement part data.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

MFP devices are complex devices that are subject to failures. When devices fail, an end user will initiate a service call. Device failures can be particularly frustrating for device users. They can result in periods when a MFP is out of service, leaving users without a powerful office tool and causing user frustration when a job must wait or an alternative MFP used, such as one that is not conveniently located or one without needed capabilities that were available on the out of service MFP.

Not only are failed devices a burden on end users, they can provide significant financial cost to MFP providers. A common business model for MFPs is one wherein a distributor enters into an end user agreement where the distributer provides a device at little or no upfront cost to the end user. User charges are based a cost per page. This cost reflects device usage charges, as well as maintenance costs. Significant human resource costs are associated with receiving a service call, logging a call, scheduling a service time, dispatching a service technician, and diagnosing and repairing the device. Such service costs can lower the distributor's profitability, increase the end user's cost per page, or both.

Costs can be further increased when the technician does not have a needed part to complete a repair and must return to their premises to obtain one. This requires another service visit by the technician. An even worse situation arises when the needed part is not available in local inventory. A parts order needs to be prepared and sent to a distributor who must then process the order and facilitate delivery of needed inventory. Even if an additional expense of expedited delivery is undertaken, there is still considerable added device downtime until the part can be ordered, shipped, received and taken to the device for a second repair visit.

### BRIEF DESCRIPTION OF THE DRAWINGS

Various embodiments will become better understood with regard to the following description, appended claims and accompanying drawings wherein:

FIG. 1 is an example embodiment of a predictive parts inventory control system;

FIG. 2 is a networked document rendering system;

FIG. 3 is an example embodiment of a digital data processing device;

FIG. 4 is a flow diagram of a device error prediction system;

FIG. 5 is a flow diagram of an example embodiment of a machine learning system;

FIG. 6 is an illustration of example machine learning algorithms;

FIG. 7 illustrates example visual depictions of machine learning algorithm results;

FIG. 8 is an example embodiment of a breakdown of device symptoms;

FIG. 9 is an example embodiment of resolution of device failures; and

FIG. 10 is a flowchart of operations of an example embodiment of a system for predictive parts ordering by machine learning.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

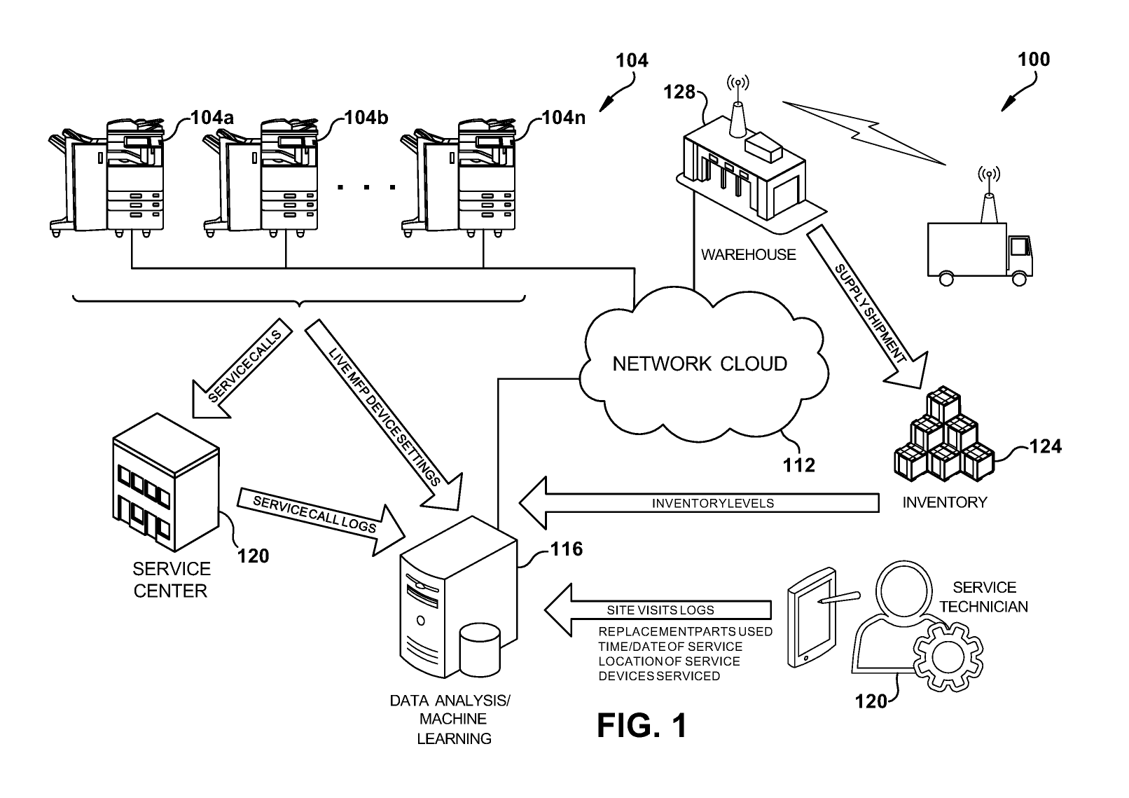

Turning to FIG. 1, illustrated is example embodiment of a predictive parts inventory control system 100 that includes a plurality of MFPs 104, illustrated with 104a, 104b through 104n. The MFPs 104 are dispersed geographically. One or more MFPs 104 may be located at a single business location 108, over multiple locations for a single business, or among multiple businesses. All MFPs 104 are configured for data communication via network cloud 112, suitably comprised of some or all of a local area network (LAN) or wide area network (WAN) which may comprise the global Internet. Also in data communication with network cloud 112 is a data analysis and machine learning service suitably including one or more servers as illustrated by server 116. MFPs 104 each include one or more components configured to monitor one or more states of the device which are reported to server 116 which also stores additional information such as repair histories and device maintenance schedules, suitably coordinated with one or more service technicians. Server 116 also stores location information for MFPs 104. Location information is suitably a geographic location determined for each MFP 104. Location information may be preset by a device physical location description, device installation address, device IP address information, and the like. Location information may also be determined by an MFP 104 itself, such as with GPS positioning, cell tower sector positioning, RF triangulation or the like.

Server 116 accumulates MFP device status data including a current device state for each MFP 104, which data is suitably obtained by real time reporting, a periodic polling by the server or periodic reporting initiated for each MFP 104 or MFP network. Device state data may include data reflective of error conditions, device settings, page counts, or toner or ink levels. Server 116 also receives service call log data from one or more service centers such as service center 120. Device servicing may be typically initiated by a customer service call. An incoming service call is logged and ultimately a service technician 120 is dispatched to address an associated device issue. Service technician 120 then fixes the associated device using one or more replacement parts and a report is then sent to server 116. A technician report may include a list of a replacement part or parts used, a time or date of service, a location of service, identification of service devices, and the like. Ongoing or periodic reporting of a level of inventory 124 is also sent to server 116. Server 116, via application of machine learning such as that detailed herein, determines what parts are likely to be needed over a future service window and compares this to a level of inventory 124. If it is determined that current inventory 124 will not be sufficient over this window, a parts order is sent to warehouse 128 for shipment and delivery in advance of predicted service calls.

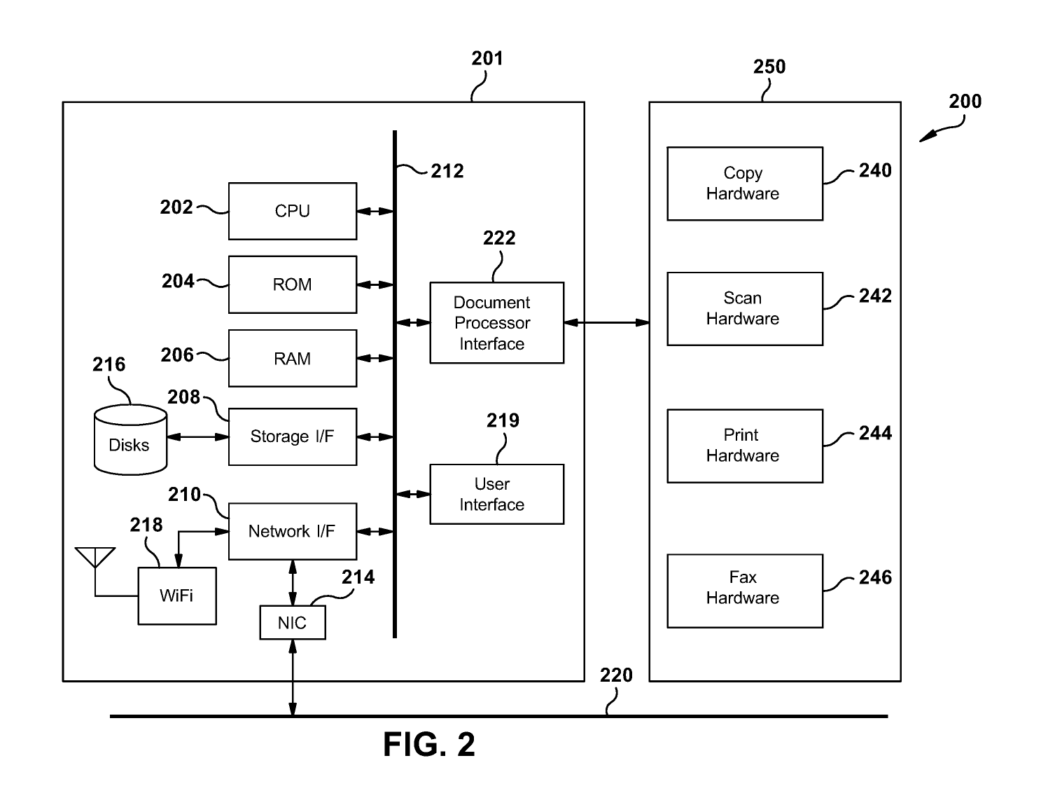

Turning now to FIG. 2 illustrated is an example embodiment of a networked digital device comprised of document rendering system 200 suitably comprised within an MFP, such as with MFPs 104 of FIG. 1. It will be appreciated that an MFP includes an intelligent controller 201 which is itself a computer system. Thus, an MFP can itself function as a cloud server with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 219 for interfacing with displays, keyboards, touchscreens, mice, trackballs and the like.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

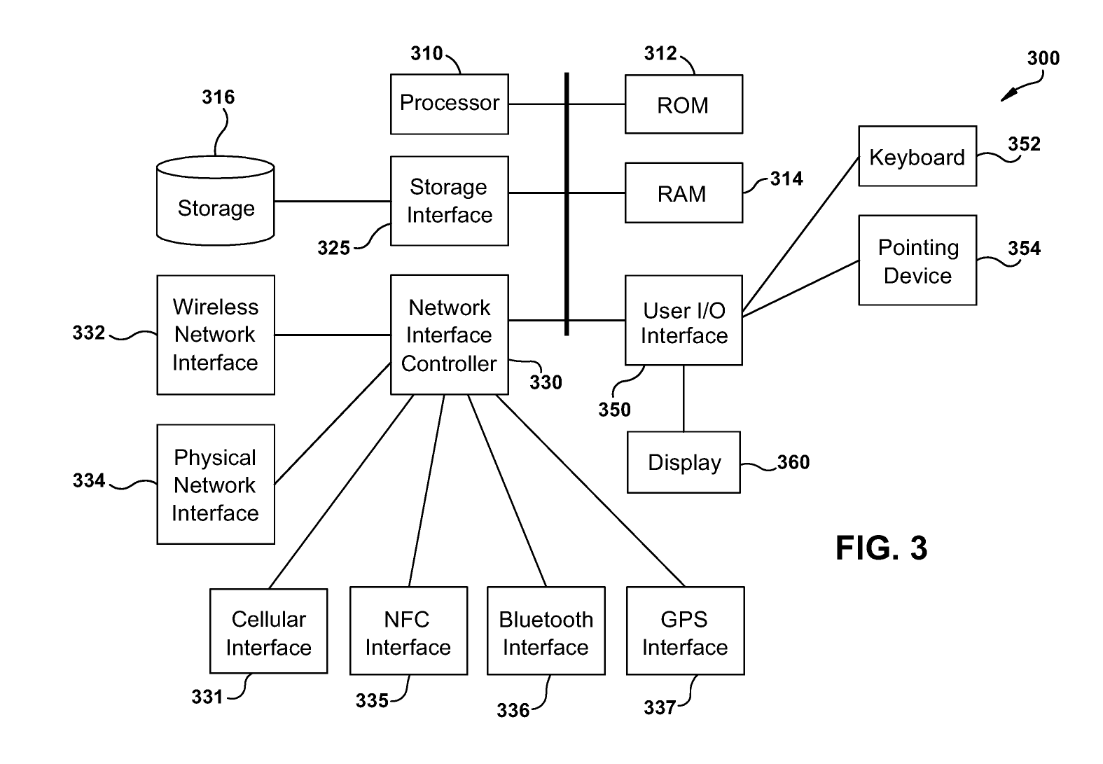

Turning now to FIG. 3, illustrated is an example embodiment of a digital data processing device 300 such as tablet computer 120 or server 116 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 331 such as when the digital device is a cell phone or tablet computer. Also included is NFC interface 335, Bluetooth interface 336 and GPS interface 337. A user input/output interface 350 suitably provides a gateway to devices such as keyboard 352, pointing device 354, and display 360, suitably comprised of a touch-screen display. It will be understood that the computational platform to realize the system as detailed further below is suitably implemented on any or all of devices as described above.

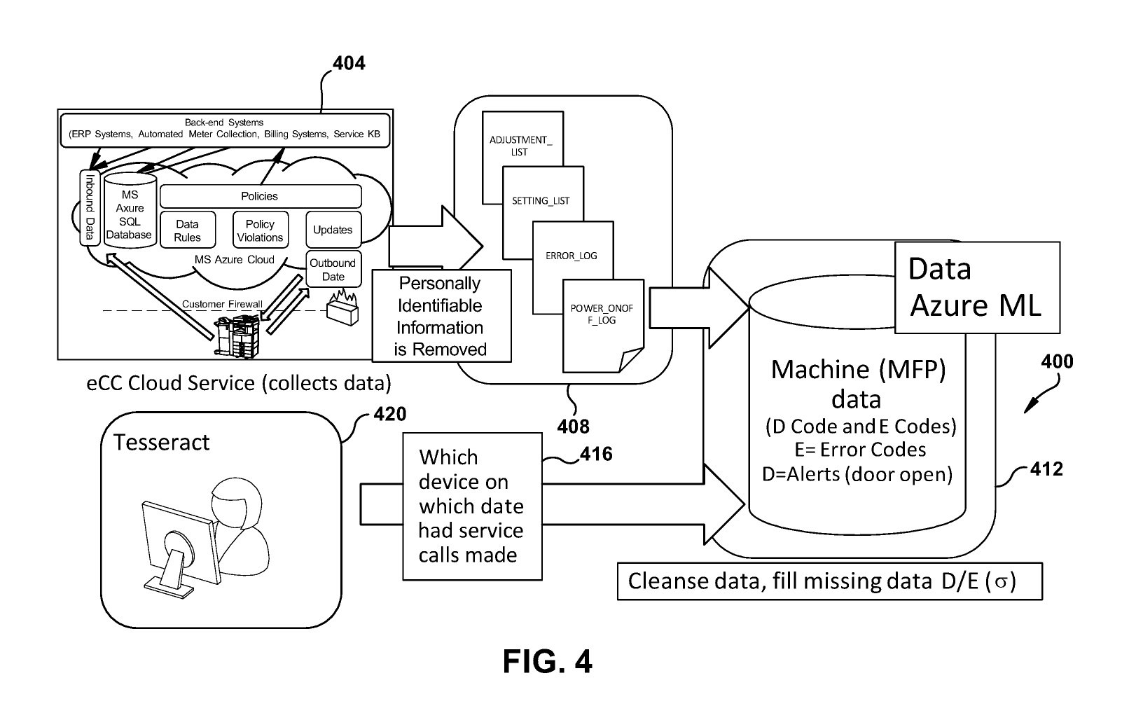

FIG. 4 is a flow diagram of a device error prediction system 400 such as one implemented in conjunction with server 116 of FIG. 1. Device monitoring is suitably accomplished with a device management system 404. By way of particular example, Toshiba TEC MFP devices are configurable and monitor able via their e-BRIDGE CloudConnect (eCC web) interface. e-BRIDGE CloudConnect is an integrated system of embedded and cloud-based applications that provide functionality to support remote monitoring and management of Toshiba MFPs. It enables management of configuration settings through automated interaction. e-BRIDGE CloudConnect gathers service information from connected MFPs, including meter data, to speed issue diagnosis and resolution.

Device management system 404 provides device state information 408 for application of machine learning and analysis for predictive device failures by a suitable machine learning platform 412 such as Microsoft Azure. Additional information 416 for such prediction, such as device service log information, is provided by a suitable CMMS (Computerized Maintenance Management System (or Software)) 420, and is sometimes referred to as Enterprise Asset Management (EAM). By way of particular example a CMMS system 420 can be based on CMMS Software, Field Service Software, or Field Force Automation Software provided by Tessaract Corporation.

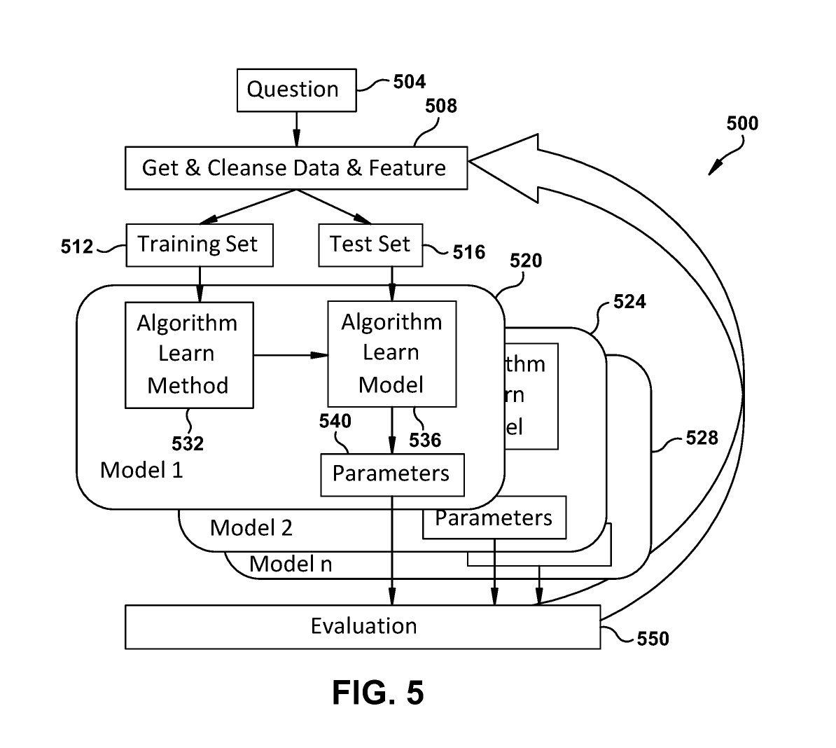

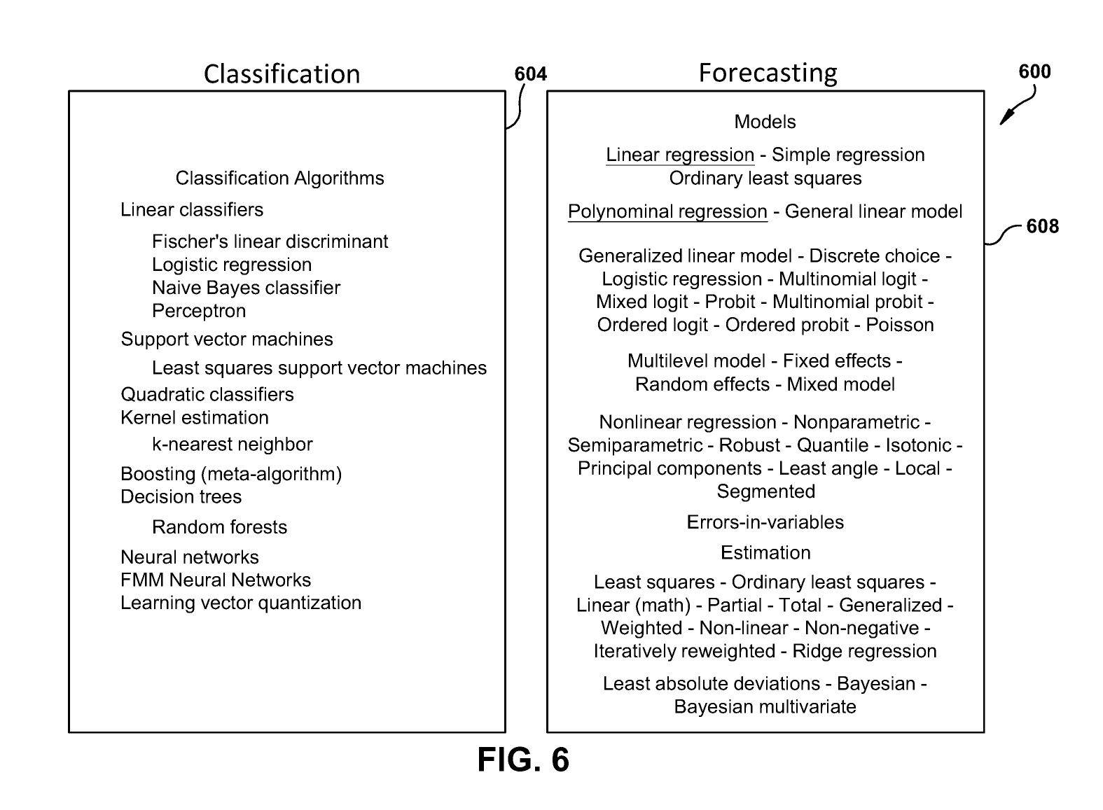

FIG. 5 illustrates a flow diagram 500 of an example embodiment of a machine learning system. In the example system, the process starts with one or more questions 504, such as when will a device likely fail and what aspects or aspects will be associated with such failure. Data is retrieved and cleansed of unneeded or problematic data at 508 and this data is provided for both training 512 and testing 516. These results are provided to a machine learning system, suitably comprised of one or more learning models such as learning models 520, 524 and 528. Each learning model 520, 524, 528 includes one or more algorithm learn methods, such as algorithm learn methods 532 and 536 of model 520. Parameters, such as parameters 540 of model 520, are provided for evaluation at 550, and results are fed back to data acquisition at 508 for iterative calculation. FIG. 6 provides example machine learning algorithms 600 including classification algorithms 604 and forecasting algorithms 608.

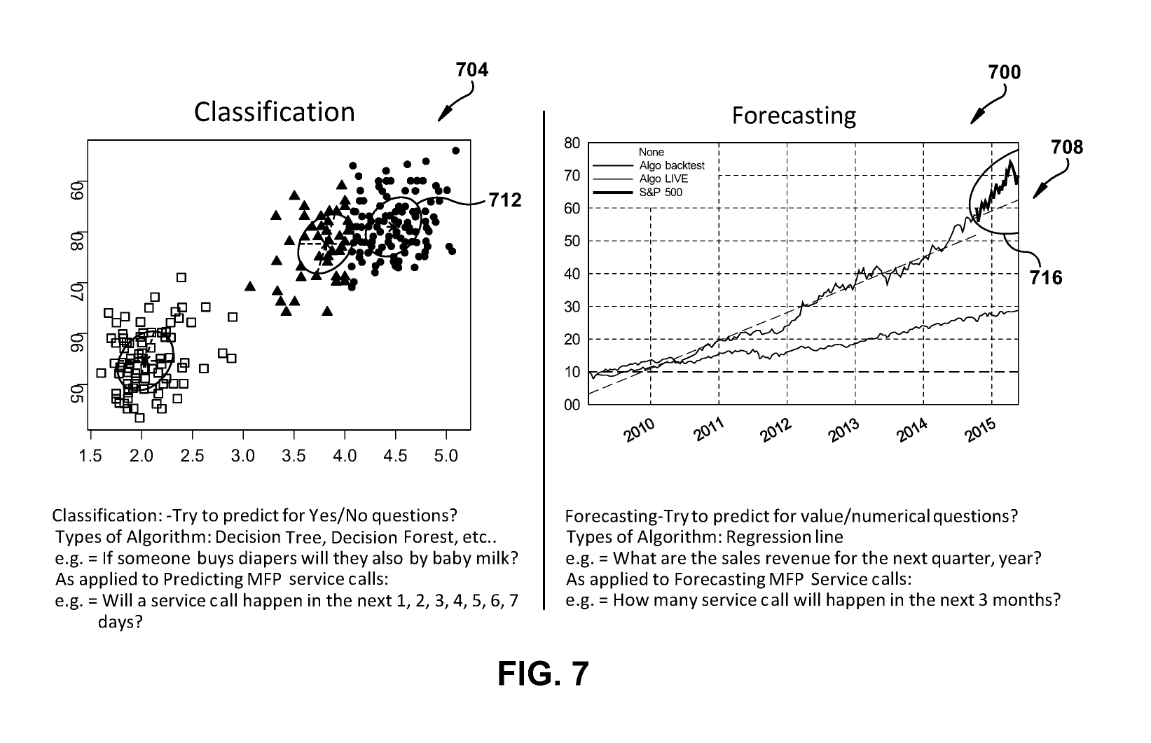

FIG. 7 provides example visual depictions of algorithm results 700, including classification results 704 and forecasting results 708. Device clusters, such as cluster 712, may be indicative of device error conditions with corresponding failure forecasting with results 716. For example, device failure can be forecasted in accordance with an application of a generalized extreme Studentized deviate test as would be understood in the art.

By way of particular example, a determination of likeliness of a forthcoming service call can be utilized to schedule device maintenance. Such scheduling is suitably integrated with service calls already scheduled or with servicing of two or more geographically proximate devices to minimize travel time needed for technician on-site visits. Suitable machine learning systems are built on available third party platforms such as R-Script, Microsoft Azure, Google Next, Kaggle.com or the like.

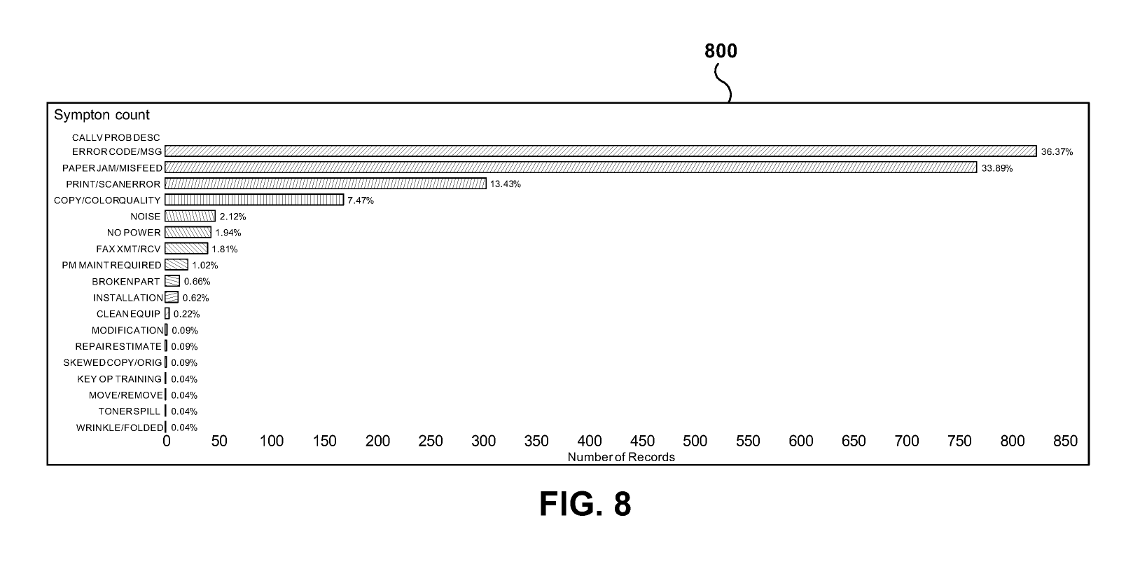

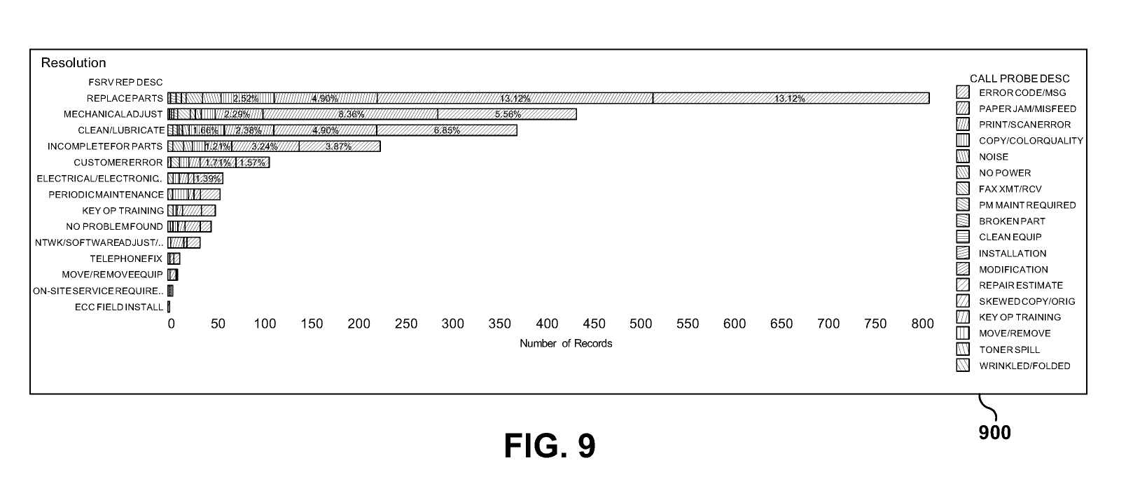

FIG. 8 is an example embodiment of breakdown of device symptoms 800 for determination of service call likelihood relative to predictive parts needed. FIG. 9 is an example embodiment of resolutions 900 comprising needed replacement parts.

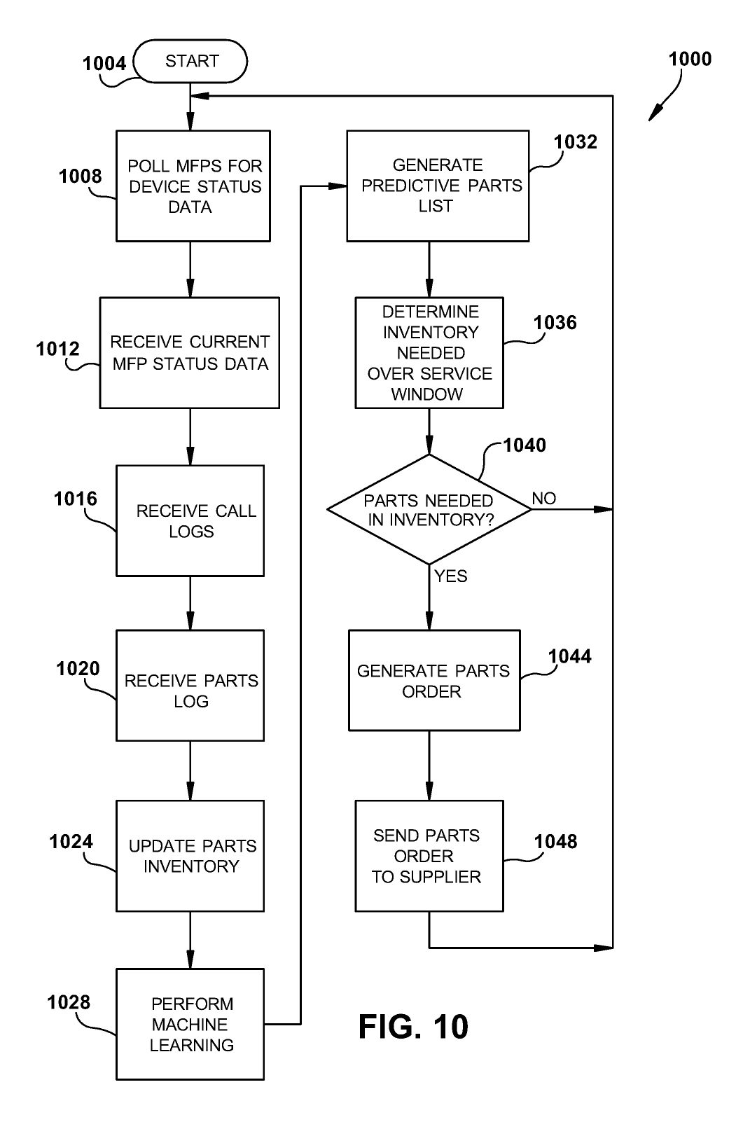

FIG. 10 is a flowchart 1000 of an example embodiment of a system for predictive parts ordering by machine learning. The process commences at block 1004 and a poll for device status is made at block 1008. Current MFP status data is received at block 1012. Call logs are received at block 1016. Parts logs are received at block 1020. Parts inventory is updated at block 1024 in accordance with a report of inventory currently available to for service calls, with the inventory suitably updated in accordance with newly received parts log information. Machine learning, such as that detailed above, is applied to MFP status data, call log data and associated service history data, and parts log data at block 1028, and a predictive parts list is generated at block 1032. For example, based on previous services performed on MFPs, machine learning can detect patterns that can be used to predict future service events based on the status data received from MFPs. The predictive parts list can be generated based on the type of services that will likely need to be performed. A determination is made relative to predicted parts needed and available inventory levels over a selected service window at block 1036. By way of example, a service window may be set at one month, and a prediction of needed inventory over that month can be made and corresponding orders placed. If existing inventory is deemed adequate at block 1040, which determination may be made with additional parts over and above predicted needs for availably assurance, the process returns to block 1008. If inventory is predicted to be insufficient at block 1040, a parts order for projected parts deficiencies is generated at block 1044 and an ensuing order is sent to a supplier at block 1048. The process then returns to block 1008 for another poll.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor and associated memory; and
a network interface configured to receive device status data from each of a plurality of multifunction peripherals into the memory,
wherein the memory is configured to store service history data for each of the multifunction peripherals,
wherein the memory is further configured to store service call history data for the multifunction peripherals,
wherein the memory is further configured to store replacement parts data corresponding to replacement parts used in prior repairs of the multifunction peripherals,
wherein the processor is configured to detect patterns in the service history data, the service call history data and the replacement parts data,
wherein the processor is further configured generate predictive replacement part data for future replacement parts that will be needed by the multifunction peripherals based at least in part on the device status data and the detected patterns, and
wherein the processor is further configured to output the predictive replacement part data.

2. The system of claim 1 wherein the processor is further configured to generate a parts order corresponding to replacement parts needed in accordance with the predictive replacement part data.

3. The system of claim 2 wherein the processor is further configured to send the parts order to an associated parts supplier via the network interface.

4. The system of claim 3 wherein the processor is further configured to generate updated replacement parts data in connection with the parts order.

5. The system of claim 1 wherein the network interface is further configured for ongoing receipt of device status data and wherein the processor is further configured to update the device status data in the memory in accordance with the ongoing receipt.

6. The system of claim 5 wherein the processor is further configured to poll the multifunction peripherals for the ongoing receipt of device status data in accordance with a preselected interval.

7. The system of claim 1 wherein the network interface is further configured for ongoing receipt of service history data and wherein the processor is further configured to update the stored service history data in accordance with the ongoing receipt.

8. The system of claim 1 wherein the network interface is further configured for ongoing receipt of service call data and wherein the processor is further configured to update stored service call history data in accordance with the ongoing receipt.

9. A method comprising
receiving device status data from each of a plurality of multifunction peripherals into a memory via a network interface,
storing service history data for each of the multifunction peripherals;
storing service call history data for the multifunction peripherals;
storing replacement parts data corresponding to replacement parts used in prior repairs of the multifunction peripherals;
detecting, via a processor, patterns in the service history data, the service call history data and the replacement parts data;
generating, via the processor, predictive replacement part data for future replacement parts that will be needed by the multifunction peripherals based at least in part on the device status data and the detected patterns; and
outputting the predictive replacement part data.

10. The method of claim 9 further comprising generating a parts order corresponding to replacement parts needed in accordance with the predictive replacement part data.

11. The method of claim 10 further comprising sending the parts order to an associated parts supplier via the network interface.

12. The method of claim 11 further comprising generating updated replacement parts data in connection with the parts order.

13. The method of claim 9 further comprising receiving ongoing device status data and updating the device status data in the memory in accordance with the ongoing receipt.

14. The method of method 13 further comprising polling the multifunction peripherals for the ongoing receipt of device status data in accordance with a preselected interval.

15. The method of claim 9 further comprising receiving ongoing service history data and updating the stored service history data in accordance with the ongoing receipt.

16. The method of claim 9 further comprising receiving ongoing service call data and updating stored service call history data in accordance with the ongoing receipt.

17. A method comprising:
periodically communicating current device status data from each of a plurality of multifunction peripherals to a server;
periodically communicating service call log data relative to servicing of the multifunction peripherals to the server from an associated device service center;
periodically communicating replacement parts data corresponding to multifunction peripheral replacement parts used to service the multifunction peripherals responsive to service calls reflected in the service call log data;
performing ongoing machine learning predictive of replacement parts needed for future service calls for the multifunction peripherals in accordance with device status data, service call log data and replacements parts data; and
generating a list of predicted replacement parts needed from the machine learning.

18. The method of claim 17 further comprising periodically polling the multifunction peripherals to receive current device status data.

19. The method of claim 17 further comprising sending a parts order corresponding to the list of predicted replacement parts to an associated supplier.

20. The method of claim 19 further comprising sending the parts order for predicted replacement parts needed over a preselected time duration.
